(19) United States
(12) Patent Application Publication
(10) Pub. No.: US 2014/0242454 A1
(43) Pub. Date: Aug. 28, 2014

(54) ELECTROLYTE WITH SOLID ELECTROLYTE INTERFACE PROMOTERS

(71) Applicant: Toyota Motor Engineering & Manufacturing North America, Inc., Erlanger, KY (US)

(72) Inventors: Monique N. Richard, Ann Arbor, MI (US); Alvaro Masias, Ann Arbor, MI (US)

(73) Assignee: Toyota Motor Engineering & Manufacturing North America, Inc., Erlanger, KY (US)

(21) Appl. No.: 14/271,324

(22) Filed: May 6, 2014

Related U.S. Application Data
(62) Division of application No. 13/076,352, filed on Mar. 30, 2011.

(51) Int. Cl. H01M 10/052; H01M 10/0567

(52) U.S. Cl. CPC H01M 10/052; H01M 10/0567; H01M 2300/0025; H01M 2220/20
USPC 429/188

(57) ABSTRACT

An electrolyte solution usable in a lithium or lithium-ion battery, among other types of batteries that offers one or more of the following: improved stability (e.g., stable discharge capacities even after several cycles), elimination of the risk of unintentionally producing hydrochloric acid, improved thermal stability, and reduced production costs associated with manufacturing a battery. Indeed, the inventors have discovered an unexpected result that by including an additive to a dinnimitride salt (e.g., LiDN), the discharge capacity of the battery may improve beyond what is available in the prior art, including LiPF6. For example, production costs may be decreased since LiDN is not water-sensitive, so precautions to ensure that the compound is not exposed to water may be avoided. Further benefits include thermal stability since LiDN may be more thermally stable when compared to LiPF6.

### CROSS REFERENCE TO RELATED APPLICATIONS

The present application is a divisional application of co-pending U.S. patent application Ser. No. 13/076,352, entitled “Electrolyte with Solid Electrolyte Interface Promoters,” filed on Mar. 30, 2011, the entire disclosure of which is hereby incorporated by reference herein.

### BACKGROUND

1. Field

The present invention relates to batteries, and more particularly, relates to the electrolyte and additive combinations used within the battery.

2. Description of the Related Art

As part of the recent global trend towards becoming “green”, considerable time and investment have been expended on the development of various renewable technologies and other more environmentally-friendly sources of energy. With respect to automobiles, researchers and car manufacturers are developing environmentally-friendlier vehicles that rely less on gas or other traditional fuels, and more on efficient energy sources, such as a car battery. While current battery technology has advanced throughout the years, there is much room for improvement, especially with respect to lithium and lithium-ion batteries currently used in the automobile industry.

More particularly, when a lithium battery is charged, the lithium moves from the cathode to the anode. During the battery charging phase, the cathode is oxidized contemporaneously with the reduction of the anode. However, the anode composition may also impact the behavior of the battery. For example, when a battery anode contains a lithium metal, the reaction of lithium and electrolyte occurs immediately. However, when the battery anode contains carbon or an alloy material, the lithium reacts with electrolyte when the electrode undergoes reduction. Regardless of the anode composition, the reaction will continue indefinitely and consume all of the lithium in the cell, unless a barrier is in place to prevent the lithium from contacting the electrolyte. The barrier, otherwise known as the solid electrolyte interface (SEI) may form spontaneously when an appropriate electrolyte is used. The nature of the components of the electrolyte may determine the chemical species that form the SEI, and the resulting stability of the SEI. Therefore, the design and arrangement of the electrolyte is of significant importance.

In one scenario, an improperly designed electrolyte may cause the SEI components to dissolve in the electrolyte too quickly. In another scenario, an improperly designed electrolyte may result in a film that is very resistive (through its composition or film thickness). Thus, one goal may be to form the SEI so that it has low resistance, but maintains durability. Additionally and/or alternatively, forming the film by consuming the smallest amount of lithium possible so that the energy of the battery is maintained may be beneficial.

Towards this end, different electrolytes have been developed. For instance, in Xu et al., U.S. Pat. No. 7,682,754, lithium hexafluorophosphate (LiPF6) was used as the primary salt in the electrolyte solution. While certain advantages were achieved, namely, the ability to maintain a stable discharge capacity after multiple cycles, there are significant drawbacks to the use of LiPF6 as a primary salt. For example, LiPF6 is water-sensitive; when LiPF6 is exposed to water, dangerous hydrofluoric acid is formed. LiPF6 therefore must be carefully manufactured under specific processes and only under very dry conditions. Not surprisingly, higher manufacturing costs are incurred in ensuring that LiPF6 is kept separate and away from water. In addition, LiPF6 has poor thermal stability; LiPF6 decomposes at lower temperatures (e.g., 200 degrees Celsius) compared to other salts, and is thus much more sensitive to temperature fluctuations.

One alternative method of forming a successful SEI is to use different compounds in the electrolyte and/or the inclusion of additives.

According to Gorkovenko et al., U.S. Pat. No. 7,598,002, a combination of non-dinitramide primary salt and a dinitramide and/or nitramide additive yielded certain advantages. Gorkovenko also described the use of lithium dinitramide (LiDN) as the sole salt. However, there are several drawbacks in using the solutions proposed in Gorkovenko. Among other problems, the discharge capacity of the Gorkovenko LiDN battery dropped considerably after only a few charges, and continued to drop thereafter. FIG. 3, discussed infra, depicts this decline. The Gorkovenko LiDN battery thus could not replicate the stable discharge capacity present in a LiPF6-based battery.

Unsatisfied with the lower discharge capacity of the LiDN battery, and the drawbacks of using LiPF6 as described above, the inventors of the subject matter of the present application continued to develop/research a more optimal electrolyte solution that could maintain a high discharge output like the LiPF6 battery but did not suffer from the same sensitivities to water and temperature and high manufacturing costs.

### SUMMARY

The inventors have developed an electrolyte solution usable, in one embodiment, in a lithium or lithium-ion battery, among other types of batteries, that may offer one or more of the following advantages: (1) improved discharge output; (2) improved thermal stability; (3) minimized risk of unintentionally producing hydrofluoric acid through exposure to water; and (4) reduced production costs associated with manufacturing the battery.

In one embodiment, a lithium-ion battery includes a cathode composed of a transition metal oxide and an anode composed of a carbon-based compound. The battery further includes an electrolyte having a LiDN salt (as a primary salt) and 2% additives. As discussed herein, all references to additive concentrations (e.g., given as a percentage) refer to percent weight of the total electrolyte solution.

In one embodiment, the electrolyte of the battery includes a LiDN salt and additives selected from a group comprising non-organic compounds such as lithium bis(oxatlato)borate (LiBOB), LiPF6, lithium bis(trifluoromethylsufonyl)imide (LiTFSl), lithium chloride (LiCl), lithium fluoride (LiF), lithium sulfide (Li2S), lithium tetrafluoroborate (LiBF4), or any combinations thereof.

In one embodiment, the electrolyte of the battery includes a LiDN salt and additives selected from a group comprising organic compounds such as vinylene carbonate (VC) or 4-vinyl 3-dioxolon-2-one (VEC), or any combinations thereof.

In one embodiment, the electrolyte of the battery includes a LiDN salt and additives selected from a group comprising non-organic compounds such as LiBOB, LiPF6, LiTFSl, LiCl, LiF, Li2S, LiBF4 and organic compounds such as VC or VEC, or any combinations thereof

This Summary is included to introduce in an abbreviated form, various topics to be elaborated upon below in the Detailed Description. This Summary is not intended to identify key or essential aspects of the claimed invention or be used as an aid in determining the scope of the claims.

### BRIEF DESCRIPTION OF THE DRAWINGS

The features, obstacles, and advantages of the present invention will become more apparent from the detailed description set forth below when taken in conjunction with the drawings, wherein:

FIG. 1 depicts a perspective view of a battery according to one or more embodiments described herein;

FIG. 2 depicts a perspective view of the battery of FIG. 1 with cut-out portions to show certain features inside the battery according to one or more embodiments described herein;

FIG. 3 depicts a prior art discharge capacity graph of cycling data for a lithium ion cell with 1 M LiDN EC:EMC 1:3 electrolyte;

FIG. 4 depicts the results of a capacity performance test for a battery with electrolyte solution based on LiPF6 and LiDN, respectively, according to one or more embodiments described herein;

FIG. 5 depicts the results of a half cell (negative) performance test for a battery with electrolyte solution based on LiPF6 and LiDN, respectively, according to one or more embodiments described herein;

FIG. 6 depicts the results of a performance test between three compounds—LiDN, LiPF6 and LiDN+0.5% LiBOB according to one or more embodiments described herein; and

FIG. 7 depicts the results of a performance test between three compounds—LiDN, LiPF6 and LiDN+2% additives according to one or more embodiments described herein.

### DETAILED DESCRIPTION

Apparatus, systems and methods that implement the embodiments of the various features of the present invention will now be described with reference to the drawings. The drawings and the associated descriptions are provided to illustrate some embodiments of the present invention and not to limit the scope of the present invention. Throughout the drawings, reference numbers are re-used to indicate correspondence between referenced elements.

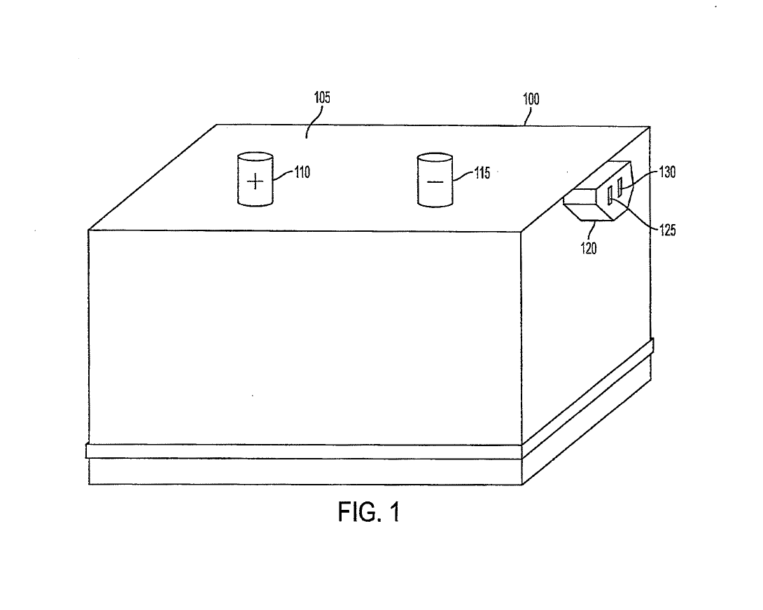

FIG. 1 illustrates a battery 100, for example, as used in a motor vehicle to power the electronic systems related to the motor vehicle. While certain aspects of the battery 100 have been omitted for clarity, the battery 100 is shown to have an outer casing 105, a terminal post 110 corresponding to the cathode, a terminal post corresponding 115 to the anode, and a plug 120 (e.g., universal plug) having two connection points, 125 and 130. The connection points 125 and 130 may be a prong (male) or a receptacle (female) for connecting a cable or wiring functioning as an electrical conduit between the battery 100 and a coupled vehicle apparatus, such as the electronic system or the engine starter (not shown).

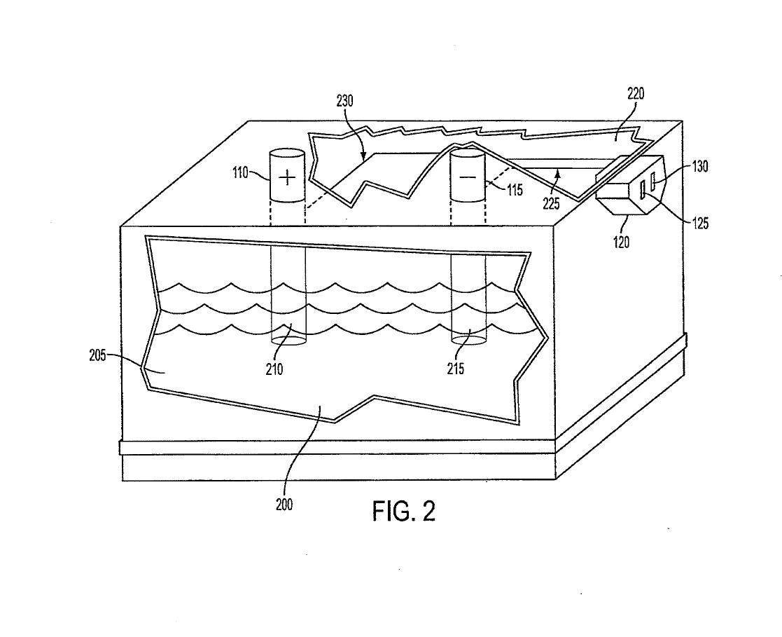

FIG. 2 illustrates a perspective view of the battery 100 of FIG. 1 with cut-out portions 200 and 220, respectively, to show certain features inside the battery 100. This figure is to be used as an example for highlighting certain features of the invention. Certain portions of the battery 100 have been omitted for clarity. Furthermore, some characteristics have been altered for clarity as well (e.g., while only shown to be partially filled in FIG. 2, electrolyte fluid 205 in practice may fill the entire cavity of the battery 100). As shown in FIG. 2, the cut-out portion 200 allows viewing of a cathode 210 extending from the terminal post 110 and an anode 215 extending from the terminal post 115. Both the cathode 210 and the anode 215 are immersed in the electrolyte fluid 205. The electrolyte fluid 205 may incorporate several elements further described herein. The cut-out portion 220 allows viewing of a conductor 230 coupled on one end to the cathode 210 and coupled on the other end to connection point 130 of the plug 120. The cut-out 220 portion further allows viewing of a conductor 225 coupled to the anode 215 on one end and coupled on the other end to the connection point 125 of the plug 120. In one embodiment, the cathode 210 is constructed out of a transition metal oxide and the anode 215 is constructed out of a carbon-based material. However, other materials may be used to construct the cathode 210 and the anode 215.

Performance of the battery 100, in part, may be impacted by how long the carbon-based anode 215 is able to function properly. A direct factor in anode functionality is whether the additives are able to form a SEI layer on the outside surface of the anode 215 based on the chemical reactions that take place during the operation of the battery 100. Elements (e.g., additives) added into the electrolyte fluid 205 or used in the manufacturing of the electrolyte fluid 205 may significantly impact the performance of the SEI. Indeed, as with the solvent, the additive(s) used determines the properties of the SEI, and hence the anode 215. Different additives will reduce at different voltages, so the selection of the additive must be carefully considered so that the additive is reduced prior to the occurrence of other deleterious reactions.

SEI performance may be measured by the discharge capacity of the battery 100 as it undergoes many cycles, with one cycle defined as one discharge and one recharge of the battery 100. In essence, SEI performance may be inferred from data related to measuring discharge capacities over a period of cycles. Stellar SEI performance may be concluded based on data suggesting that a discharge capacity is constant or near constant over a period of cycles. Conversely, less-than-optimal SEI performance may be inferred based on data illustrating that a discharge capacity is decreasing over a period of cycles.

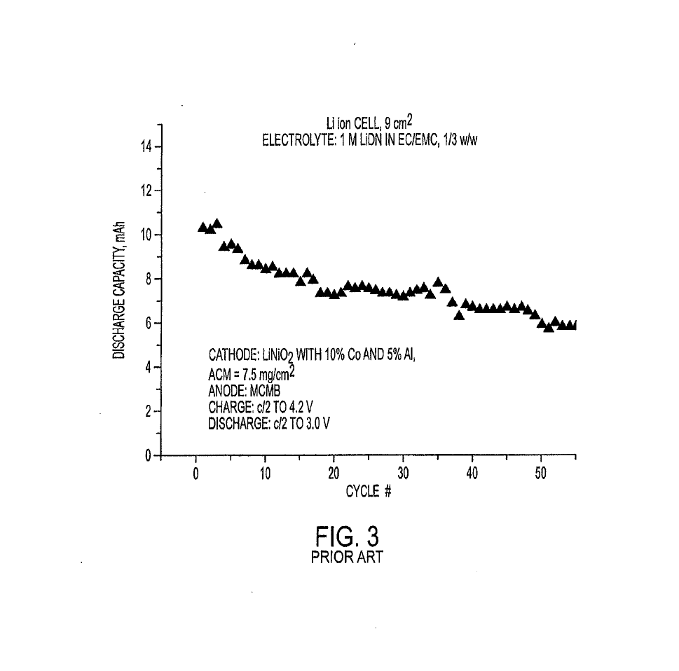

FIG. 3, reproduced from Gorkovenko et al., U.S. Pat. No. 7,598,002, is a prior art representation of a discharge capacity for a lithium-ion cell with 1 M LiDN EC:EMC 1:3 electrolyte. As shown in FIG. 3, the discharge capacity for the Gorkovenko LiDN battery dropped from 10-11 mAh to 8-9 mAh after less than 10 cycles, and continued to drop through the next 40 cycles to about 6 mAh. By the end of the 50th cycle, the Gorkovenko LiDN battery discharged approximately 40% less power than it did at the outset. The severity of the drop, as well as its continued downward trend, is indicative of poor SEI performance.

### Experimentation

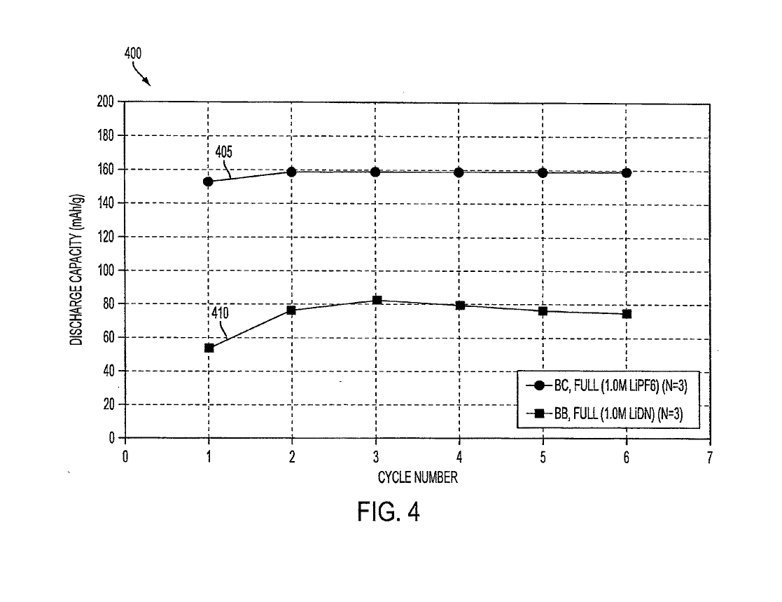

FIG. 4 illustrates results obtained in a preliminary discharge capacity test performed on a full cell battery with a first electrolyte solution 405 having a 1 M LiPF6 salt (industry standard) and on a full cell battery with a second electrolyte solution 410 having a 1 M LiDN salt. As shown in graph 400, the 1 M LiDN salt electrolyte solution 410 not only has a lower discharge capacity compared to the 1 M LiPF6 salt electrolyte solution 405, but also appears to decrease in effectiveness between the third cycle and the sixth cycle. The results were not surprising and confirmed that the use of LiDN as the sole salt, while providing some advantages, could not replicate certain aspects of success achieved by the LiPF6 based salt, namely, higher discharge capacity. The inventors began to study the cause of the decreased discharge capacities by isolating and testing the cathode (e.g., cathode 210) and the anode (e.g., anode 215) separately in the electrolyte solution (e.g., electrolyte fluid 205).

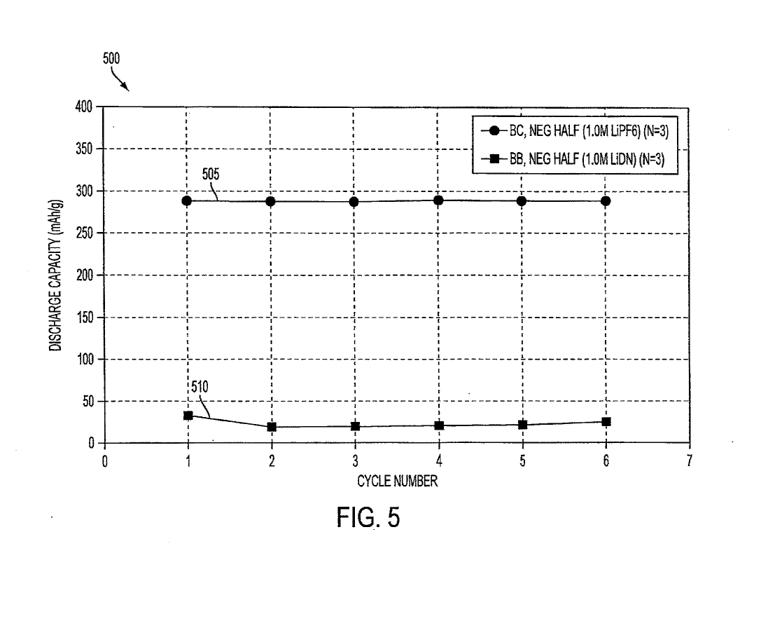

Further investigation led to the data illustrated in graph 500 of FIG. 5, which depicts the result obtained for a negative (anode) half cell with a first electrolyte solution 505 having a 1 M LiPF6 salt, and for a negative (anode) half cell with a second electrolyte solution 510 having a 1 M LiDN salt. As shown, the 1 M LiDN salt electrolyte solution 510 has a lower discharge capacity than the 1 M LiPF6 salt electrolyte solution 505. The results of data illustrated in FIG. 5 thus appear to indicate that improving the performance of the anode (e.g., anode 215) of the battery (e.g., battery 100) would lead to the overall increase of the performance of the battery (e.g., battery 100). One hypothesis tested by the experimentation was the addition of additives to the electrolyte solution (e.g., electrolyte fluid 205).

### Example 1

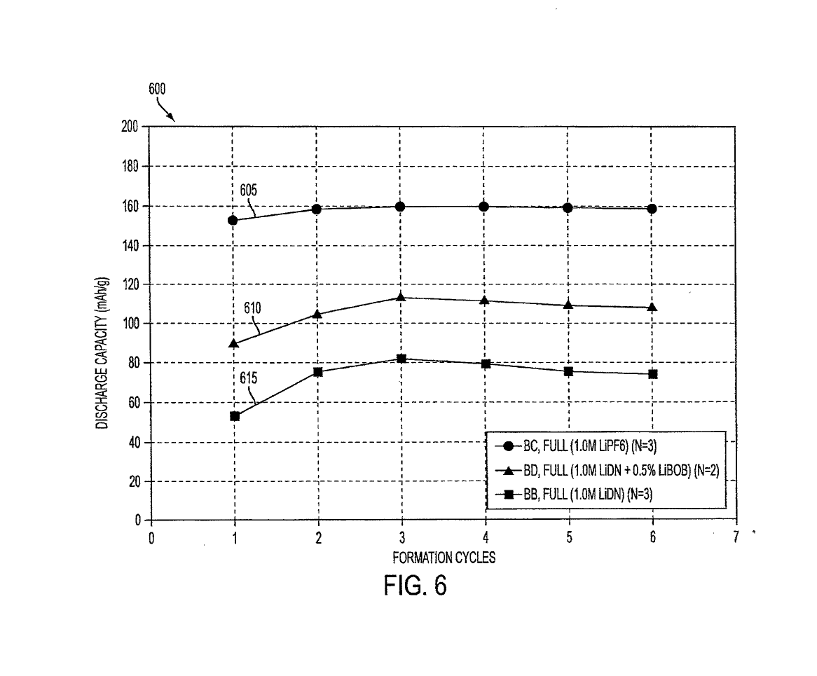

FIG. 6 includes a graph 600 illustrating discharge capacities for a 1 M LiPF6 salt electrolyte solution 605, a 1 M LiDN salt electrolyte solution with a 0.5% LiBOB additive 610 and a 1 M LiDN salt electrolyte solution without any additives 615. As the graph 600 shows, the 1 M LiPF6 salt electrolyte solution 605 performed the best with respect to discharge capacity. Noteworthy was the discovery that the addition of the 0.5% LiBOB to the 1 M LiDN salt electrolyte solution (shown by the 1 M LiDN salt electrolyte solution with a 0.5% LiBOB additive 610) yielded discharge capacities higher than that yielded by the 1 M LiDN salt electrolyte solution 615 over the first 6 cycles. Although the discharge capacities achieved by the 1 M LiDN+0.5% LiBOB salt electrolyte solution 610 did not match the levels yielded by the 1 M LiPF6 salt electrolyte solution 605, the results suggest that further improved performance of LiDN-based electrolyte may be possible if the additive is selected properly with respect to, for example, concentration, among other factors.

### Example 2

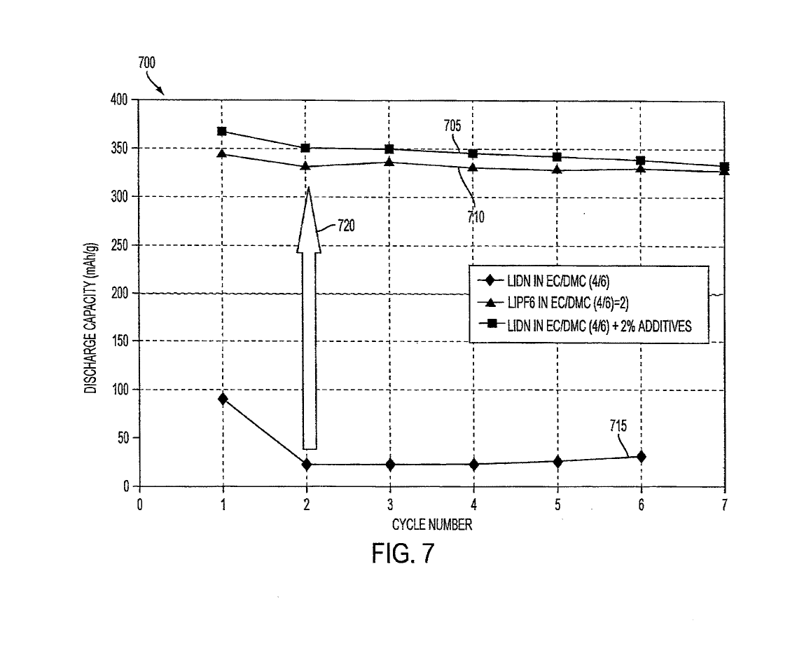

In one embodiment, the additive was raised to 2% and added to the 1 M LiDN. For example, the additive may include VC, among other additives. The magnitude of the resulting increase was unexpected: as illustrated by graph 700 of FIG. 7, the discharge capacities of the 1 M LiDN+2% additive solution 705 not only exceeded the 1 M LiDN solution 715, but surpassed even that of the 1 M LiPF6 solution 710. Arrow 720 shows the extent of improvement over the 1 M LiDN solution 715. These remarkable results indicate that the use of the 1 M LiDN+2% additive solution 705 may be superior to the 1 M LiPF6solution 710 with respect to discharge capacity while simultaneously improving on the drawbacks of the LiPF6-based solution, and does not suffer from the above described drawbacks presented by any LiPF6-based electrolyte solutions. While some further improvement on discharge capacity was expected with the further introduction of additives, the improvement in discharge capacity beyond industry standard was not expected. Instead, the inventors anticipated that improvement in discharge capacity would level off with further introduction of additives beyond the 0.5% concentration level and offer diminishing returns.

More particularly, the results of the discharge capacity test of the 1 M LiPF6solution 710 as shown in graph 700 of FIG. 7, indicates that the discharge capacity of the corresponding battery maintains a level between 350 and 325 mAh/g over the first seven cycles. However, unexpectedly, the 1 M LiDN+2% additive solution 705 offers a higher discharge capacity for each and every cycle over the first seven cycles. As shown, after the first cycle, the discharge capacity of the 1 M LiPF6 solution 710 was slightly below 350 mAh/g while the discharge capacity of the 1 M LiDN solution 705 was well above 350 mAh/g (near 375 mAh/g), or over 7% higher than the discharge capacity of the 1 M LiPF6 solution 710. Even after the sixth cycle, the discharge capacity of the 1 M LiDN+2% additive solution 705 was about 340 mAh/g or over 3% higher than the discharge capacity (about 330 mAh/g) of the 1 M LiPF6 solution 710. Such improved performance is likely attributable to the concentration of additives being substantial enough to form the SEI on the outside surface of the anode (e.g., anode 215 of FIG. 2) without impacting performance of the battery (e.g., battery 100) in other ways. In addition, the differential in discharge capacity (e.g., as evidenced by the slope of FIG. 7) for the 1 M LiDN+2% additive solution 705 is shown to be relatively flat, thereby providing another desirable benefit of forming the SEI so that it has low resistance, while maintaining durability. Indeed, results providing for this “near flat or near zero slope” of the discharge capacity over multiple cycles renders the 1 M LiDN+2% additive solution 705 a very commercially viable solution as it appears to provide advantages over both the LiPF6-based electrolyte and the LiDN (without additives) electrolyte with minimal drawbacks.

### Example 3

While Example 2 illustrates results when the additive concentration is 2% (as added to the 1 M LiDN solution), the improved performance may also be achievable, in one embodiment, with additive concentrations within a small range (e.g., between 0.5% and 10%). However, even within this range, performance may vary. Based on the obtained results (e.g., by comparing the results of 2% additive to the results of the 0.5% additive), the inventors naturally expected that increasing the additive concentration would further improve performance. However, further testing of additives up to 10% additives did not support this hypothesis. Unexpectedly, 2%-5% additives yielded better results than both 0.5% additive concentration and >5% additives concentration. Indeed, additive concentrations between 2%-5% may be preferred over additive concentrations between 5%-10%. In one embodiment, additive concentration within the range of 1.75%-2.25% is preferred.

### Example 4

In addition to concentration, the particular additive compounds may impact battery performance. In one embodiment, LiBOB may be used as the additive (e.g., as a sole 2% additive). However, in addition and/or as an alternative, other additives may also provide a significantly improved electrolyte solution for a lithium or lithium-ion battery. In one embodiment, the main salt may be LiDN and the additives include other film-forming, non-organic compounds such as LiTFSI, LiBF4, LiClO4, LiB12-xF12Hx, among other compounds. These film-forming salts may be used alone or in combination with LiBOB and each other, and may be added to the LiDN electrolyte solution in a 0.5%-5% concentration to form the additives.

### Example 5

In addition to non-organic compounds, organic compounds may also be used to form the additive. For example, VC and/or VEC may be used either alone or in combination as the additive (e.g., in addition to other organic compounds). However, using VC as the additive may provide for improved performance. Indeed, the inclusion of VC provided further unexpected results when compared to other organic compounds such as VEC. Due to similar characteristics, VC was not anticipated to provide significantly different results when compared to VEC. However, by utilizing VC as an additive, an unexpected result of improved performance over VEC was realized. More particularly, it was discovered that VC has a characteristic of high reduction protection qualities, which renders it the driver when used in a LiDN electrolyte solution (as opposed to the result when using VEC as the additive, which due to its respectively lower reduction protection, allowed LiDN to remain the driver). While either VC or VEC may be used as an additive in a LiDN electrolyte solution, using VC may be more effective as the SEI is sufficiently protected.

### Example 6

In one embodiment, the main salt is LiDN and the additives may include a combination of different compounds adding up to 0.5%-10% wt% such as LiTFSI, LiBF4, LiClO4, LiB12-xF12Hx, VC and VEC. These film-forming compounds may be used alone or in combination.

In one embodiment, the salts (e.g., LiTFSI, LiBF4, LiClO4, LiB12-xF12Hx, among other compounds) may be mixed with the non-salts (e.g., VC and/or VEC, among other compounds) to form the additive. For example, a 1.5% VC may be mixed with 0.5% LiBOB to form a 2% additive concentration.

In one embodiment, one or more solvents may be used in the production of the battery. For example, ethylene carbonate (EC) and ethylmethocarbonate (EMC) may be used to produce the electrolyte. Different volume ratios between the EC and the EMC may be incorporated. For example a 1:3 EC/EMC ratio may be employed in one embodiment. In another embodiment, at 4:6 EC/EMC ratio may be employed.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

The previous examples are provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The elements and uses of the above-described embodiments may be rearranged and combined in manners other than specifically described above, with any and all permutations within the scope of invention. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. In addition, the invention is not limited to the illustrated embodiments, and all embodiments of the invention need not necessarily achieve all the advantages or purposes or possess all characteristics identified herein.

What is claimed is:

1. An electrochemical cell comprising:
an anode;
a cathode coupled to the anode; and
an electrolyte solution configured to activate the anode and the cathode, the electrolyte solution including a lithium dinitramide (LiDN) salt as the primary salt with a molarity of at least 0.8 M and a vinylene carbonate (VC) additive having a weight concentration of 1.75% to 2.25% of the total weight of the electrolyte solution.

2. The electrochemical cell of claim 2, wherein the weight concentration of the VC additive is 2% of the total weight of the electrolyte solution.

3. The electrochemical cell of claim 3, wherein a cycle of the electrochemical cell includes a discharging operation that decreases a cell voltage of the electrochemical cell from an upper limit cut-off voltage to a lower limit cut-off voltage by a constant discharge current flowing from the electrochemical cell during a predetermined time period at a predetermined temperature and further includes a charging operation that increases the cell voltage from the lower limit cut-off voltage to the upper limit cut-off voltage,
wherein a discharge capacity is defined as an amount of electric charge that can be withdrawn from the electrochemical cell during the discharging operation, and
wherein the VC additive utilized with the LiDN salt increases the discharge capacity as compared with a battery having LiDN as the sole salt.

4. The electrochemical cell of claim 3, wherein the VC additive utilized with the LiDN salt substantially maintains the discharge capacity during the first sixth cycles after manufacturing of the electrochemical cell is completed.

5. The electrochemical cell of claim 3, wherein a graph plotting the discharge capacity on a Y-axis, over the number of the cycles completed after the manufacturing of the electrochemical cell ranging from the second to the sixth cycle on an X-axis, has a near flat or near zero slope.

6. An electrolyte solution for use in a battery, the electrolyte solution comprising:
a lithium dinitramide (LiDN) salt, the LiDN salt concentration having a molarity of at least 0.8 M; and
an additive comprising vinylene carbonate (VC), a weight concentration of the additive being 1.75% to 2.25% of the total weight of the electrolyte solution.

7. The electrolyte solution of claim 6, wherein the weight concentration of the additive is 2% of the total weight of the electrolyte solution.

8. The electrolyte solution of claim 6, wherein a cycle of the battery includes a discharging operation that decreases a cell voltage of the battery from an upper limit cut-off voltage to a lower limit cut-off voltage by a constant discharge current flowing from the battery during a predetermined time period at a predetermined temperature and further includes a charging operation that increases the cell voltage from the lower limit cut-off voltage to the upper limit cut-off voltage,
wherein a discharge capacity is defined as an amount of electric charge that can be withdrawn from the battery during the discharging operation, and
wherein the additive utilized with the LiDN salt increases the discharge capacity as compared with a battery having LiDN as the sole salt.

9. The electrolyte solution of claim 8, wherein the additive utilized with the LiDN salt substantially maintains the discharge capacity during the first sixth cycles after manufacturing of the battery is completed, and the LiDN salt substantially reduces water sensitivity of the battery.

10. The electrolyte solution of claim 6, wherein a graph plotting the discharge capacity on a Y-axis, over the number of the cycles completed after the manufacturing of the electrochemical cell ranging from the second to the sixth cycle on an X-axis, has a near flat or near zero slope.
